(19) United States
(12) Patent Application Publication
(10) Pub. No.: US 2025/0222814 A1
(43) Pub. Date: Jul. 10, 2025

(54) CHARGING FACILITY

(71) Applicant: TOYOTA JIDOSHA KABUSHIKI KAISHA, Toyota-shi (JP)

(72) Inventors: Mizuki SHIRAKAWA, Toyota-shi (JP); Yutaka Kuboyama, Toyota-shi (JP)

(73) Assignee: TOYOTA JIDOSHA KABUSHIKI KAISHA, Toyota-shi (JP)

(21) Appl. No.: 18/985,043

(22) Filed: Dec. 18, 2024

(30) Foreign Application Priority Data
Jan. 9, 2024 (JP) 2024-001408

(51) Int. Cl. B60L 53/66

(52) U.S. Cl. CPC B60L 53/66

(57) ABSTRACT

A charging facility includes a plurality of power output devices, and a charging control device that charges the power storage device mounted on the vehicle using at least a part of the plurality of power output devices based on a control command from the vehicle. The charging control device sets a power output device used for charging the power storage device based on thermal damage of the plurality of power output devices. Thus, more appropriate power output devices can be selected from among the power output devices, to charge the power storage device onboard the vehicle.

### CROSS-REFERENCE TO RELATED APPLICATION

This application claims priority to Japanese Patent Application No. 2024-001408 filed on Jan. 9, 2024, incorporated herein by reference in its entirety.

### BACKGROUND

### 1. Technical Field

The present disclosure relates to a charging facility, and more particularly, to a charging facility including a charging control device that, based on a control command from a vehicle, charges a power storage device that is onboard the vehicle, using at least part of a plurality of power output devices.

### 2. Description of Related Art

Conventionally, as a charging facility of this type, there has been proposed a charging facility in which a secondary battery is charged by two parallel-connected chargers that perform output of output power in accordance with an input power command value (e.g., see Japanese Unexamined Patent Application Publication No. 2019-103264 (JP 2019-103264 A)). When a total power command value controlling total output power from the two chargers is no greater than the greatest outputtable power value of a first charger of the two chargers, this charging facility assigns the total power command value to the first charger. When the total power command value exceeds the greatest outputtable power value of the first charger, the charging facility assigns, to a second charger of the two chargers, a predetermined power value of which power conversion efficiency is no less than a predetermined value in the second charger. The charging facility distributes the total power command value to the two chargers in accordance with a distribution map, which assigns a remaining power value, obtained by subtracting a predetermined power value from the total power command value, to the first charger, until the greatest outputtable power value is exceeded. Thus, even when the chargers have regions with low power conversion efficiency, a target total power can be output.

### SUMMARY

However, in the above-described charging facility, there are cases in which desired charging power cannot be secured, due to damage caused by heat of the chargers. When heat is generated, the higher the temperature of the charger becomes, the lower the power that can be output becomes. Accordingly, when a secondary battery is charged using a charger of which the temperature has become high, there are cases in which the secondary battery cannot be charged by the greatest output power that the charger is rated at. Thus, when charging the secondary battery using a plurality of the chargers, it is necessary to control the chargers taking into consideration thermal damage (outputtable power) of each charger.

A primary object of the charging facility according to the present disclosure is to charge a power storage device onboard a vehicle by selecting more appropriate power output devices among multiple power output devices.

The charging facility according to the present disclosure adopts the following means in order to achieve the above-described main object.

A charging facility according to the present disclosure is a charging facility including a plurality of power output devices, and a charging control device configured to, based on a control command from a vehicle, charge a power storage device that is onboard the vehicle, using at least part of the power output devices, in which the charging control device sets power output devices to be used to charge the power storage device, based on thermal damage of the power output devices.

The charging facility according to the present disclosure includes multiple power output devices, and the charging control device that charges the power storage device onboard the vehicle using at least a part of the power output devices, based on the control command from the vehicle. The charging control device sets the power output devices to be used to charge the power storage device, based on the thermal damage of each power output device. Thus, more appropriate power output devices can be selected from among the power output devices, to charge the power storage device onboard the vehicle.

In the charging facility according to the present disclosure, the charging control device may determine a priority order for the power output devices in order from least thermal damage, and set the power output devices to be used to charge the power storage device in order of the priority order.

In this way, those of the power output devices having small thermal damage can be preferentially set as the power output devices to be used to charge the power storage device.

In this case, the control command is a charging power command, and the charging control device may accumulate an outputtable power of the power output devices in the order of the priority order, and set power output devices, up to an order at which an accumulated value exceeds the charging power command, as power output devices to be used to charge the power storage device.

In this way, the power storage device can be charged more appropriately based on the charging power command.

The charging control device may determine that the greater the outputtable power of the power output device is, the smaller the thermal damage is.

This is based on a fact that the outputtable power of the power output devices decrease more the greater the thermal damage thereof is.

Also, the charging control device may lower the priority order of the power output devices used for charging the power storage device the previous time.

In this way, the frequency of use of a particular power output device can be reduced, and the multiple output devices can be used for charging the power storage device relatively evenly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an outline of a configuration of a charging facility 20 according to an embodiment of the present disclosure;

FIG. 2 is a configuration diagram illustrating an outline of a configuration of an electrified vehicle 120 in which the charging facility 20 can be used;

FIG. 3 is a flow chart illustrating an exemplary charging process performed mainly by a charge ECU 30;

FIG. 4 is a flow chart illustrating an exemplary priority order process performed by the charge ECU 30;

FIG. 5 is a table showing exemplary power and priority order of the power units 24(1) to 24(8); and

FIG. 6 is a flowchart illustrating an example of the priority order setting process according to the modification.

### DETAILED DESCRIPTION OF EMBODIMENTS

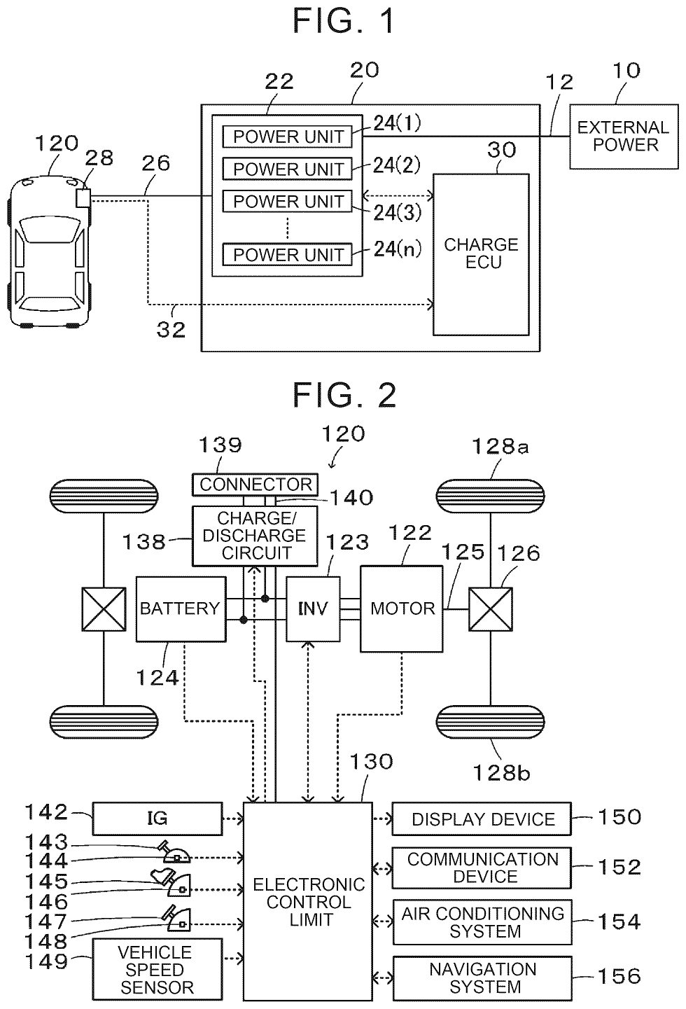

Next, a mode (embodiment) for carrying out the present disclosure will be described. FIG. 1 is a configuration diagram illustrating an outline of a configuration of a charging facility 20 as an embodiment of the present disclosure. The charging facility 20 of the embodiment is configured as a charging station, and as shown in FIG. 1, includes a power unit device 22 and a charging electronic control unit (hereinafter referred to as a “charge ECU”) 30.

The power unit device 22 is connected to the charging line 26 of the charging connector 28 which is connected to the power line 12 from the external power 10 and connected to the connector 139 (inlet) of electrified vehicle 120. The power unit device 22 uses electric power from the external power 10 to charge the battery 124 mounted on electrified vehicle 120. In the power unit device 22, a plurality of power units 24(1) to 24(n) functioning as power output devices are connected in parallel. The power units 24(1) to 24(n) are configured to be the same by an AC/DC converter that converts AC power from the external power 10 into DC power, a DC/DC converter that converts DC power, or the like.

The charge ECU 30 is configured as a microcomputer centered on CPU. The charge ECU 30 receives the temperatures T(1) to T(n) of the power units 24(1) to 24(n) from the power unit device 22. Based on the temperatures T(1) to T(n) of the respective power units 24(1) to 24(n), the charge ECU 30 sets the outputtable power P(1) to P(n) of the respective power units 24(1) to 24(n). The outputtable power P is set to be smaller due to thermal damage as the temperature T of the power unit is higher, and a rated value is set at room temperature. The charge ECU 30 is connected to the electronic control unit 130 of electrified vehicle 120 via an electrified vehicle 120 and the communication line 32, and communicates with the vehicle-side.

Examples of vehicles that can use the charging facility 20 of the embodiment include the electrified vehicle 120 illustrated in FIG. 2. Electrified vehicle 120 includes a motor 122, an inverter 123, a battery 124, a charge/discharge circuit 138, a connector 139, and an electronic control unit 130.

The motor 122 is configured as, for example, a synchronous generator motor. The rotor of the motor 122 is connected to a drive shaft 125 connected to the drive wheel 128a, 128b via a differential gear 126. The motor 122 is driven when DC power from the battery 124 is converted into three-phase AC power by the inverter 123 and three-phase AC power is applied by the inverter 123. The battery 124 is configured as a well-known lithium-ion secondary battery or a nickel-hydrogen secondary battery.

The charge/discharge circuit 138 has one end connected to a power line connected to the battery 124, and the other end connected to a connector 139 for connecting to the charging connector 28 of the charging facility 20. The charge/discharge circuit 138 includes a charge/discharge relay (not shown), and can be connected to or disconnected from the battery 124 by the charge/discharge relay.

The electronic control unit 130 is configured as a microcomputer that is not shown but is configured with a CPU as a center. The electronic control unit 130 receives signals from various sensors via an input port. For example, the electronic control unit 130 receives an ignition signal from the ignition switch 142, a shift position SP from the shift position sensor 144 for detecting the position of the shift lever 143, an accelerator operation amount Acc from the accelerator pedal position sensor 146 for detecting the depression amount of the accelerator pedal 145, a brake position BP from the brake pedal position sensor 148 for detecting the depression amount of the brake pedal 147, a vehicle speed V from the vehicle speed sensor 149, and the like. Further, the electronic control unit 130 receives a rotational position θ from a rotational position sensor (not shown) that detects a rotational position of the motor 122, a battery voltage Vb from a voltage sensor (not shown) attached to an output terminal of the battery 124, a battery current Ib from a current sensor (not shown) attached to an output terminal of the battery 124, a charge/discharge current Ichg from a current sensor attached to a charge/discharge voltage Vchg, charge/discharge circuit 138 from a voltage sensor attached to the charge/discharge circuit 138, and the like.

The electronic control unit 130 outputs various control signals via an output port. For example, the electronic control unit 130 outputs a display control signal to the display device 150, a communication control signal to the communication device 152, and an air-conditioning control signal to the air-conditioning device 154. The electronic control unit 130 outputs a switching control signal for switching a switching element (not shown) to the inverter 123 for driving the motor 122, a drive control signal to a system main relay (not shown) attached in the vicinity of the battery 124, and a drive control signal to a charge/discharge relay (not shown) attached to the charge/discharge circuit 138. The electronic control unit 130 communicates with a navigation system 156 that displays various types of information and performs route guidance. The electronic control unit 130 is connected to a communication line 140 for communicating with a charge ECU 30 of the charging facility 20 when the charging connector 28 of the charging facility 20 is connected to the connector 139. The communication line 140 belongs to the communication line 32 when the charging connector 28 is connected to the connector 139.

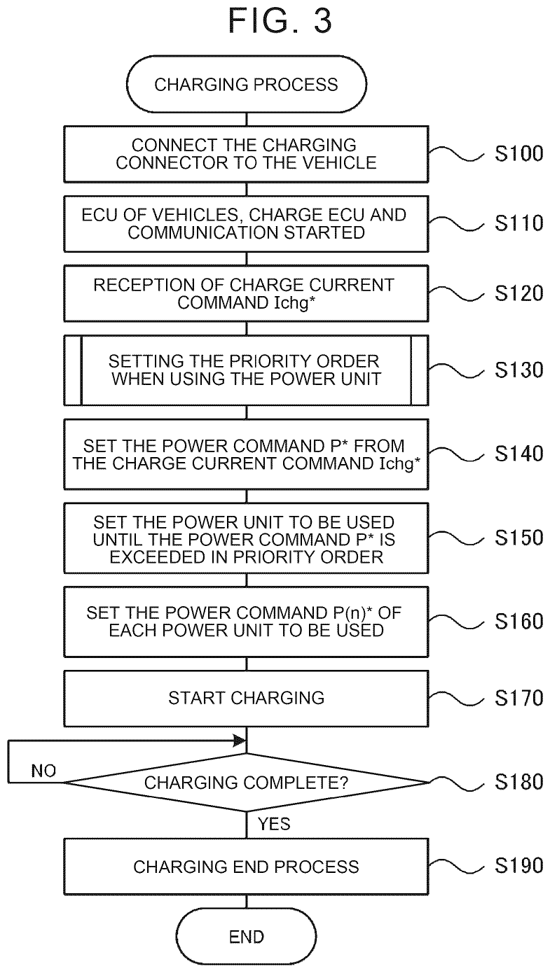

Next, the operation of the charging facility 20 configured in this way, in particular, the operation when charging the battery 124 of electrified vehicle 120 will be described. FIG. 3 is a flow chart illustrating an exemplary charging process mainly executed by the charge ECU 30. The charging process begins by first connecting the charging connector 28 to the connector 39 of electrified vehicle 120 (S100) and initiating communication between the electronic control unit 130 of electrified vehicle 120 and the charge ECU 30 (S110).

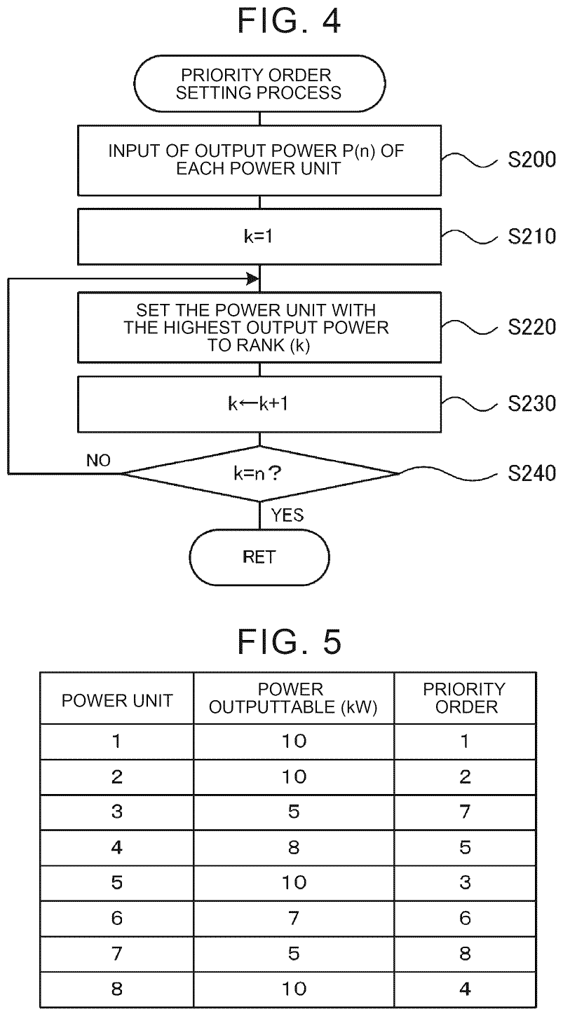

Next, the charge ECU 30 receives a charging current command Ichg* from the electronic control unit 130 of electrified vehicle 120 (S120). The charging current command Ichg* is set by the electronic control unit 130 as a charging current for efficiently charging the battery 124 based on the power storage ratio SOC, the thermal Tb, and the like of the battery 124. Subsequently, the charge ECU 30 sets priority order as the order of use for charging among the power units 24(1) to 24(n) (S130). This processing is performed by the priority order setting processing illustrated in FIG. 4.

In the priority order process of FIG. 4, first, the outputtable power P(1) to P(n) of the power units 24(1) to 24(n) is inputted (S200). Then, the value 1 is set to the variable k (S210), and the order (k) is set to the power unit having the largest outputtable power until the variable k matches n (S240). At the same time, a process (S220) of deleting the power unit whose rank is set from the ranking process and a process (S230) of incrementing the variable k by a value-1 are repeated. The priority order (1) to (n) is set in each of the power units 24(1) to 24(n) by such processing. Note that since the outputtable power is set as a larger value as the thermal damage of the power unit is smaller, the priority order is set in descending order of the thermal damage.

When priority order (1) to (n) are set as the order used for charging among the power units 24(1) to 24(n) in this manner, the charging power command P* is set based on the charging current command Ichg* (S140). Subsequently, the power unit to be used for charging is set until the sum of the outputtable power of the power units set in the order of priority order (1) to (n) exceeds the charging power command P* (S150). Now, it is assumed that the power unit device 22 has eight power units 24(1) to 24(8), the outputtable power P(1) to P(8) of the power units 24(1) to 24(8) are shown in the list illustrated in FIG. 5, and the charging power command P* is 50 kW. In this case, the priority order of the power units 24(1) to 24(8) are 1, 2, 7, 5, 3, 6, 8, and 4. The power units used are power units 24(1), 24(2), 24(5), 24(8), 24(4), and 24(6) with priority order of 1 to 6.

When the power unit used for charging is set, the power command P(n)* of each power unit is set (S160), and charging is started using the power command P(n)* of each power unit (S170). The power command P(n)* of the respective power units may be set as 10 KW of the power that can be output, for example, for the power units 24(1), 24(2), 24(5), and 24(8) with low thermal damage, in the example of the list of FIG. 5, and may be set as 8 kW for the power unit 24(4) that is thermally damaged and 2 kW for the power unit 24(6). The power units 24(4) and 24(7) may be set to be 5 kW or the like.

Then, it waits until the charge end is determined (S180), and the charge end process is performed (S190), and this process is ended. The end of charging is determined when the full charging of the battery 124 is transmitted from the electronic control unit 130, when the user instructs the end of charging, or the like. The charging end process includes stopping the operation of each of the power units 24(1) to 24(n), turning off a relay (not shown), and the like.

In the charging facility 20 according to the embodiment described above, the power units 24(1) to 24(n) are priority order in descending order of the power that can be output (in descending order of the thermal damage), and the power units used for charging the battery 124 are set and charged in descending priority order. Accordingly, the battery 124 mounted on electrified vehicle 120 can be charged by selecting a power unit having a smaller thermal damage and a larger outputtable power among the plurality of power units 24(1) to 24(n). In addition, the higher the outputtable power of the power unit (the closer the outputtable power value is to the maximum output value), the more efficient the output is, and thus the battery 124 can be charged efficiently.

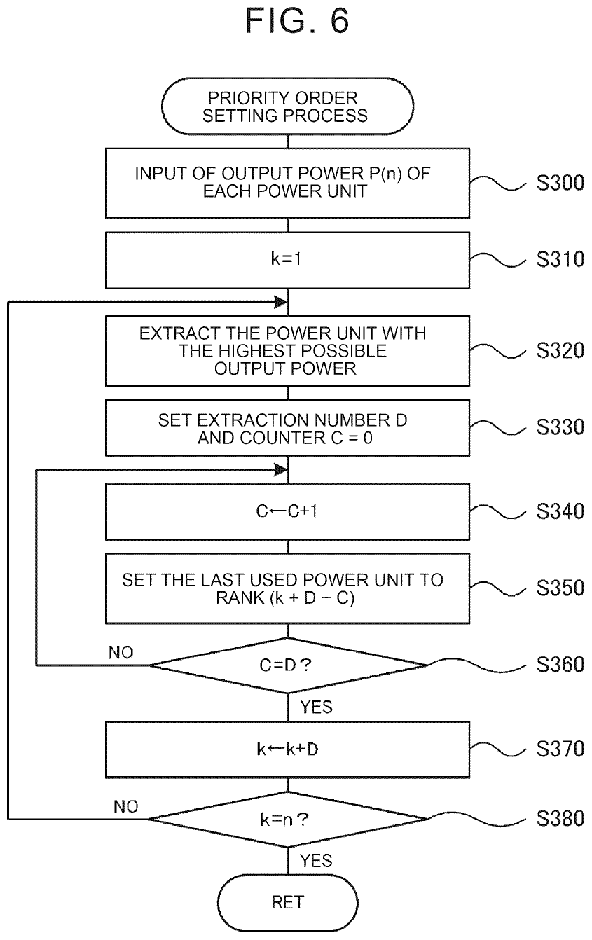

In the charging facility 20 of the embodiment, priority order is determined in descending order of power that can be output (in descending order of thermal damage) with respect to the power units 24(1) to 24(n). However, for the power units having the same outputtable power, the priority order of the power units used to charge the battery 124 may be lowered. An example of priority order setting processing in this case is shown in FIG. 6. In this embodiment, the outputtable power P(1) to P(n) of the power units 24(1) to 24(n) are inputted (S300), the variable k is set to 1 (S310), and the processes from S320 to S370 are repeated until the variable k matches n (S380). In the repetitive process, first, the power unit having the largest outputtable power is extracted (S320), the number of extracted power units is set as the extraction number D, and the counter C is set to 0 (S330). Then, until the counter C matches the extraction number D (S360), the process (S340) of incrementing the counter C by the value 1, and the process (S350) of setting the power unit used last among the extracted power units to the rank (k+D−C) and deleting the power unit having the rank set from the ranking process are repeated. For example, consider a case where three of the power units 24(1), 24(2), 24(3) are extracted at k=1, the power unit 24(1) is used for the previous charging, the power unit 24(2) is not used for the previous charging, and the power unit 24(3) is not used for the previous charging. In this case, the order of the power units 24(1), 24(2), and 24(3) is 3, 2, and 1. In this way, the power units of the same outputtable power are priority order in the order used previously, and the power units used last time are priority order. When the order of the power units of the extraction number D is set, a value obtained by adding the extraction number D to k is set as a new value k (S370).

If the priority order setting process of the modification of FIG. 6 is used, not only the priority order is determined in descending order of the outputtable power (in descending order of the thermal damage) for each of the power units 24(1) to 24(n), but also the priority order can be determined in the order in which the power units of the same outputtable power are used. As a result, it is possible to suppress the use of only a part of the power units of the same outputtable power. Therefore, it is possible to prevent the load from being biased to only a part of the power units, and to average the life of the power units. Therefore, the battery 124 mounted on electrified vehicle 120 can be charged by appropriately selecting a power unit having a smaller thermal damage and a larger outputtable power among the plurality of power units 24(1) to 24(n).

The correspondence between the main elements of the embodiments and the main elements of the disclosure described in the column of the means for solving the problem will be described. In the embodiment, the plurality of power units 24(1) to 24(n) corresponds to a “plurality of power outputting devices”, and electrified vehicle 120 corresponds to a “vehicle”. In the embodiment, the battery 124 corresponds to a “power storage device”, the charge ECU 30 corresponds to a “charging control device”, and the charging facility 20 corresponds to a “charging facility”.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the present disclosure has been described above using the embodiment, the present disclosure is not limited to the embodiment in any way, and may be implemented in various modes without departing from the scope of the present disclosure.

The present disclosure is applicable to a manufacturing industry of a charging facility and the like.

What is claimed is:

1. A charging facility comprising:
a plurality of power output devices; and
a charging control device configured to, based on a control command from a vehicle, charge a power storage device that is onboard the vehicle, using at least part of the power output devices, wherein the charging control device sets a power output device to be used to charge the power storage device, based on thermal damage of the power output devices.

2. The charging facility according to claim 1, wherein the charging control device determines a priority order for the power output devices in order from least of the thermal damage, and sets the power output devices to be used to charge the power storage device in order of the priority order.

3. The charging facility according to claim 2, wherein:
the control command is a charging power command; and
the charging control device accumulates an outputtable power of the power output devices in the order of the priority order, and sets power output devices, up to an order at which an accumulated value exceeds the charging power command, as power output devices to be used to charge the power storage device.

4. The charging facility according to claim 2, wherein the charging control device determines that the greater the outputtable power of the power output device is, the smaller the thermal damage is.

5. The charging facility according to claim 1, wherein the charging control device lowers the priority order of the power output devices used for charging the power storage device a previous time.
